(19) United States
(12) Patent Application Publication
(10) Pub. No.: US 2015/0074001 A1
(43) Pub. Date: Mar. 12, 2015

(54) Method for Crowdsourcing and Creating a Collaborative Multimedia Project and Product

(71) Applicant: Matthew Lee, Sunnyvale, CA (US)

(72) Inventor: Matthew Lee, Sunnyvale, CA (US)

(21) Appl. No.: 14/023,470

(22) Filed: Sep. 11, 2013

(51) Int. Cl. G06Q 10/10

(52) U.S. Cl. CPC G06Q 10/101
USPC 705/300

(57) ABSTRACT

The current method and system utilize crowdsourcing for content generation and production of multimedia through online collaboration. The current method not only creates a platform for online content providers to gain exposure and get feedback, it uses these broad powers of the crowd to select, refine and produce media that enables broader production and reward of partial contributions and serves a larger audience with self-selected interests.

### CROSS-REFERENCE TO RELATED APPLICATIONS: None

### FEDERALLY-SPONSORED RESEARCH: Not applicable

### SEQUENCE LISTING: Not applicable

### BACKGROUND OF THE INVENTION

The present invention concerns a method and product for crowdsourcing and creating a collaborative multimedia project, specifically online, where members of the online community (“users”) can submit media ideas, content for open media projects and ancillary media for open projects, as well revise media ideas, content and ancillary content and contribute to the selection of media for publication in collaborative projects. Further, users can receive instant monetary awards for their successful contributions, as well as a return from future sales of the related product.

Internet advancements carry many benefits, such as the ability for anyone with online access to disseminate multimedia (i.e., self-publish). Along with its vast benefits, use of the interne for publication presents some key impediments for individuals interested in getting their work in front of a broad audience or in making a return on their creative investments primarily due to the shear volume of online content. Thus, the potential benefits of an instant, freely accessed worldwide platform are substantially self-limiting without a platform that attracts and connects producers, contributors and users of particular content. This method hones and exploits the power of the online masses (the “crowd”) to select, refine and promote the content they want to consume.

Crowdsourcing is an increasingly common tool for tasks such as financing startups, aggregating real-time traffic updates, and correcting computer-translated language. Whereas these systems use crowdsourcing to produce an output using a product (e.g., a mobile application for the “crowd” to report real-time traffic) with established parameters, the new method utilizes crowdsourcing to select the product itself (e.g., a type of book or book collection), as well as contribute to—and determine the method of—its output.

In most online systems that employ crowdsourcing, solutions to tasks are solicited via open calls to large-scale communities and the initiator of the call selects the “winners.” Examples of such tasks are disclosed in Pub. No. US 2010/0293026 A1 (the “DiPalantino Publication”), including: the graphical design of logos, the creation of a marketing plan, the identification and labeling of an image, and the answering of an individual's question. As disclosed in the DiPalantino publication, current crowdsourcing systems that provide a monetary incentive or reward are common in that the reward amount is set and offered by the initiator of the call, such as creating a logo in an online contest where an initiator offers $100 to the creator of the logo he ultimately selects for his product or business. In such system, there is no opportunity for collaboration, for advertising one's work, for contributing to a greater project goal or for earning a return on future sales of the project to which one successfully contributes.

The current method not only creates a platform for online content providers to gain exposure and get feedback, it uses these broad powers of the crowd to select, refine and produce media that enables broader production of partial contributions and serves a larger audience with self-selected interests. This broad platform for production of publicly created and contributed multimedia addresses the key problems faced by inexperienced or otherwise ignorant creators of online multimedia, including: how to earn compensation; how to attract and build an audience; how to protect one's work; how to receive constructive feedback; how to promote fragmented works, such as short stories or song lyrics.

The embodiments described herein are not limited to implementations that solve any or all of the disadvantages of known crowdsourcing or media compilation systems.

### SUMMARY OF THE INVENTION

The new system for crowdsourcing production of multimedia generally utilizes a website through which content providers, modifiers and viewers can conceive, create, refine and produce multimedia that is, by its nature, guaranteed to appeal to a specific audience. Whether building a book, producing a song, writing a screenplay or refining an invention, this new method for crowdsourcing enables users to define a desirable, marketable and potentially profitable product that otherwise would not exist. Traditional models for producing literary compendiums, for example, include public submission of stories that comply with an editor- or publisher-selected theme. The audience is not involved in selection of the compendium theme or selection of the content for publication. The contributor of a story chosen by the editor or publisher for publication might be rewarded with nominal compensation and authorship credit, but a contributor's involvement and benefits end there.

Unlike such traditional media aggregation models, the new method provides contributors with endless opportunity for publication, exposure and earnings by enabling them to interact with the platform and each other in many ways, including: submitting media ideas; submitting content for open media projects; submitting ancillary media for open projects (e.g., submitting images to accompany articles for an open book product); revising media ideas, content and ancillary content; commenting and rating media ideas, content and ancillary content; viewing existing media, including produced works and works-in-progress; following other users or projects; viewing affiliate companies and visiting affiliate websites; creating and viewing user profiles, comprising user information, user status and accrued points, recent user activity and user's followers; linking social media profiles to user profiles or platform website content; and sharing media content via social media outlets.

In one embodiment of the system, users contribute to each element of book production—theme selection, content diversity and production method. The market for literary compendiums is well established, but the current method improves on these tried systems with real-time submission and peer review with many users deciding the content versus the traditional model of publisher selection. This method also enables feedback on submissions such that a contributor can revise content and resubmit with a second chance at advancement to publication. This benefit is distinct from the traditional model, which employs a one-way relationship (user-to-website or user-to-publisher), where a contributor might receive a rejection letter if the submitted work is not accepted but will not receive feedback or an opportunity to revise the work and resubmit it for consideration.

In other embodiments, the multimedia product may be an engineering design or audio compilation where a user signs up to play a role in the production of a particular product based on the user's expertise. For instance, a musical audio project may consist of independent users performing one or more roles, such as producer, songwriter, singer, lyricist, instruments and rapper, who are working toward production of a common product. Likewise, an engineering design project may comprise roles such as designer, mass properties, CAD, electronics, thermal, programming, stress, reliability, controls and quality.

In another embodiment, the method includes an option for users to contribute individual chapters to a novel or other sequentially building type of book. For example, fans of a particular movie, television or comic series can submit chapters for a fan-fiction work, and other users of the platform—particularly other fans of the subject work—can vote on the submitted chapters for inclusion in the final work.

In yet another embodiment, affiliated businesses or other types of organization can register for private “host rooms” where the user base and media content is controlled by the host corporation or organization. This embodiment largely mirrors the new method in its operations but is segregated from influence of the broader, public platform's user and content base. For example, a large social media company can register a host room for creation of a book on the company's history wherein its employees can register as users to submit and vote on stories about the company for inclusion in the book.

In another embodiment, the product of crowdsourced multimedia collaboration can be created and released incrementally in a “live” dynamic, enabling consumers to experience and/or contribute to the work as it is being produced. For example, the method may be applied to live book production, whereby a work-initiating user (an author) submits a first chapter for platform user viewing, receives feedback and input for follow-on chapters, and builds a captive audience while the book is being written chapter-by-chapter, sentence-by-sentence or even word-by-word.

In another embodiment, users can purchase or be given a private “host room” wherein they can create media and manage permissions for other users to view, edit, comment, rate, and add to the user's content. As part of the services provided, the user will be allowed to publish and/or put up for sale their material through the website platform. Users will also gain advertising through the website by featuring popular media, allowing purchase for advertising, and/or by means of suggesting their media to users who view similar media.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWING(S)

FIG. 1 is a block diagram of an environment within which an embodiment of the method gray be deployed;

FIG. 2 is a flow diagram of a method of crowdsourcing multimedia production, in accordance with some embodiments of the present invention;

FIG. 3 is a flow diagram of a method, in accordance with an embodiment, of crowdsourcing the theme, content and publication of a book;

FIG. 4 is a flow diagram of a method of crowdsourcing multimedia production, in accordance with some embodiments of the present invention, specifically depicting a user's interaction with the method;

FIG. 5 is a flow diagram of a method of crowdsourcing a live book.

### DETAILED DESCRIPTION OF THE INVENTION

Implementations of the present disclosure are directed to systems and methods of conceiving, building and producing crowdsourced or other user-generated multimedia content. The detailed description provided below in connection with the appended diagrams is intended as a description of the embodiments presented and is not intended to represent the only forms in which the embodiments disclosed herein may be implemented or utilized. The description sets forth the functions of the example and the sequence of steps for implementing and operating the embodiments presented. However, the same or equivalent functions and sequences may be accomplished by different embodiments or for different purposes than those disclosed.

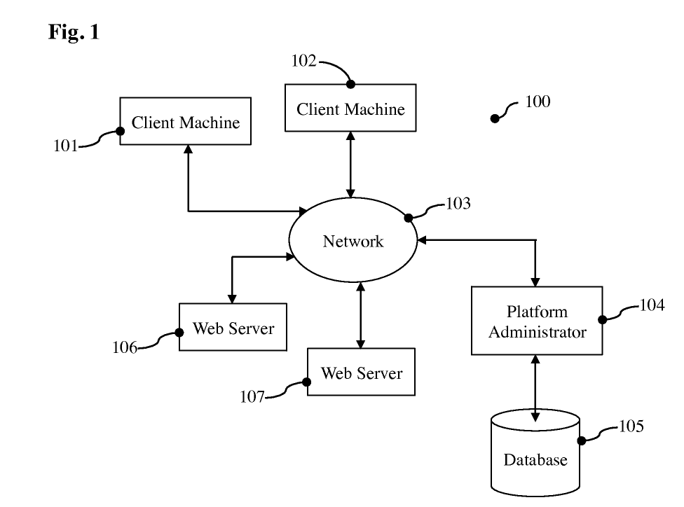

FIG. 1 is a block diagram of an environment within which an embodiment of the method may be deployed 100. Users access the network 103 via client machines 101 102, which may be any computing device capable of accessing the internet. The network 103 is supported by one or more web servers 106 107, upon which the network relies for services such as Internet, email and other account hosting. :A platform administrator 104 interacts directly with the network 103 and as an intermediary between the network and one or more databases 105 that store organized user and content data.

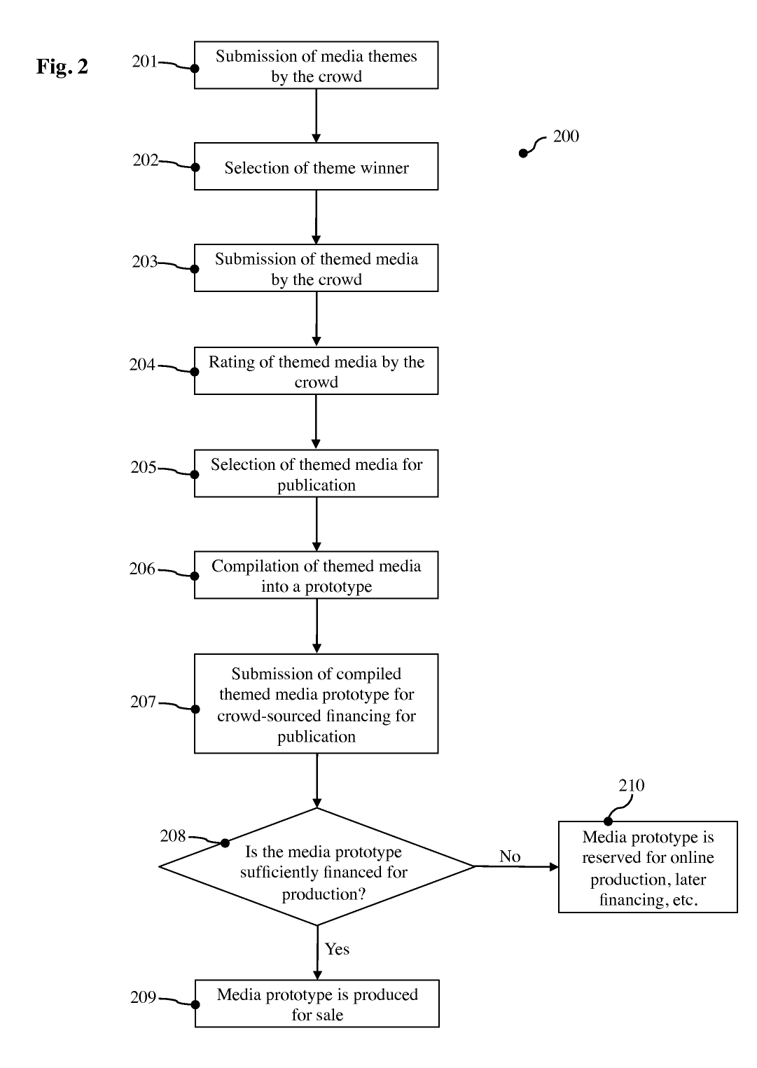

FIG. 2 is a flow diagram of a method of crowdsourcing multimedia production in accordance with some embodiments of the present invention 200. The general method is initiated by submission of a media theme 201 by users of the platform or website which is the initial crowd-wide input. A “winning” theme is selected 202 by the platform administrator based on either the sole discretion of the administrator or on crowd-provided feedback on the submitted ideas by methods such as voting, ranking, rating and commenting. Users then submit media content (e.g. a book chapter, a game idea, an image to accompany a book segment or a song) in accordance with a selected theme 203. As content is submitted, users can vote for preferred content 204 by methods such as rating and commenting. Voted media content is reviewed by he platform administrator, and top-voted, qualifying content is selected for publication 205. Qualification may be determined by factors such as age--appropriateness, theme compliance and any desirable pre-set criteria. The platform administrator will assemble the selected content into a prototype 206 (e.g., a book, an audio album, a video compilation, etc.). The prototype can then submitted for crowdsourced financing for physical production 207 208, whereby production of a physical, marketable product is dependent on crowd election and sponsorship 209 and lack of adequate sponsorship 210 results in reservation of the prototype for online production or later sponsorship.

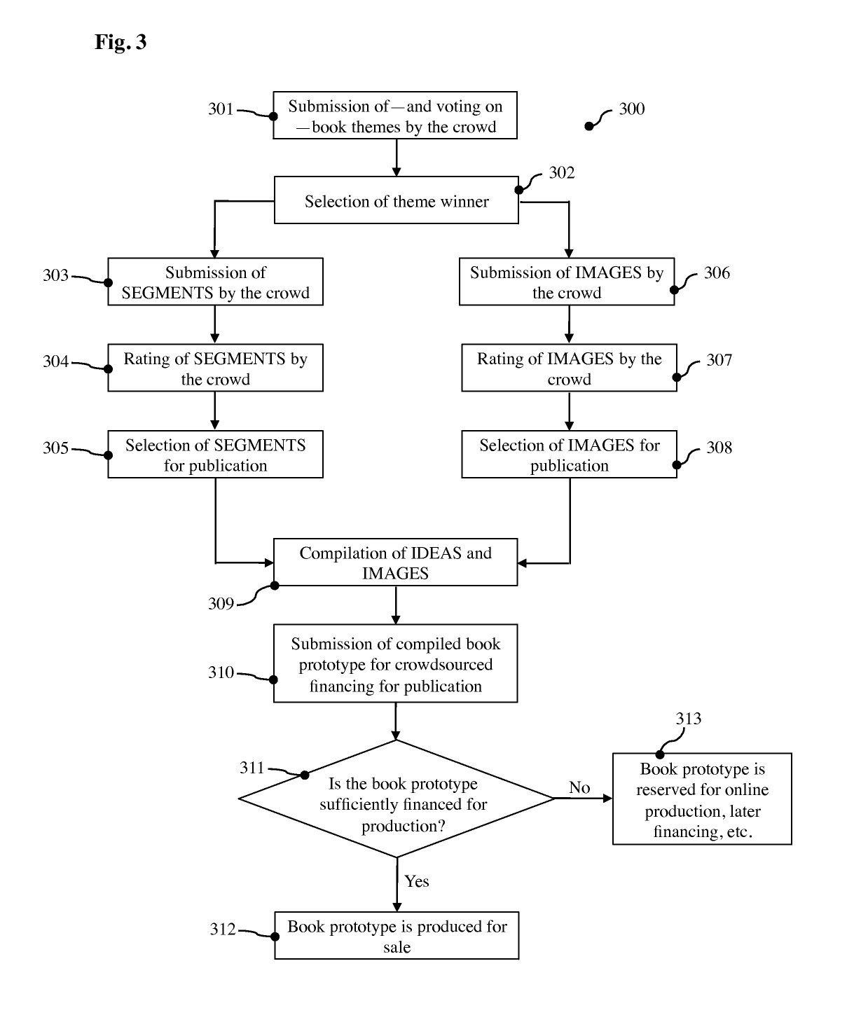

FIG. 3 is a flow diagram. of a method, in accordance with an embodiment, of crowdsourcing the theme, content and publication of a “collection book” 300, which consists of a set number of independent stories or segments (e.g., a book comprised of unrelated travel stories or a collection of new games to play while on a long car ride). Users (the “crowd”) submit book theme ideas or vote for another's submitted book theme via the platform 301. A “winning” book theme is selected 302 by the platform administrator based on either the sole discretion of the administrator or on crowd votes in support of a submitted theme. In one embodiment, content for the book is then provided by users who can submit either written segments 302 (e.g., ideas for new games to play while on a long car ride) and/or images that will be associated with the ten segments 306. As content is submitted, it is visible to users on the website, and users can rate, comment or otherwise vote on submitted segments 304 and images 307. “Winning” book segments 305 and images 308 are selected by the platform administrator based on either the sole discretion of the administrator or on crowd ratings, comments or other voting data in support of submitted content. The platform administrator then compiles the winning segments and images into a prototype 309 and submits the book for crowdsourced financing for publication 310 311, whereby production of a physical, marketable book is dependent on crowd election and sponsorship 312 and lack of adequate sponsorship 313 results in reservation of the book for online production/sales or later sponsorship for production via an alternative method of financing. It is of importance that users do not have to do anything other than provide content, such as finding a publisher or printing company, hiring someone to create digital copies, setting up their own online storefront, or having to work to find readers and/or contributors for their work or imagined work.

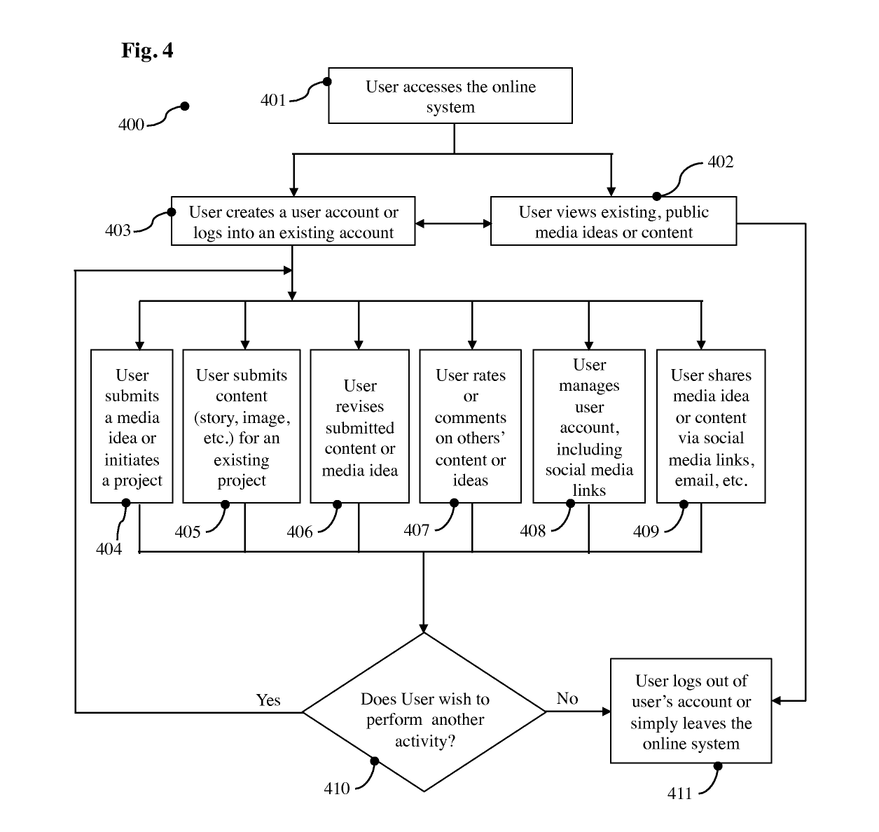

FIG. 4 is a flow diagram of a method of crowdsourcing multimedia production, in accordance with some embodiments of the present invention, specifically depicting a user's interaction with the method 400. User accesses the online platform via a website 401. On the website, a user can register for a private account or log into an existing private account 403, which will enable actions such as submitting media ideas of initiation of media projects 404, submitting content (story, image, etc.) for an existing project 405, revising user's submitted content 406, rating or commenting on others' content and ideas 407, managing user's account, including social media links 408, and sharing media ideas or content via social media links, email, etc. 409. Alternatively, a user accessing the website can interact with the website without creating a user account 402, but it action is limited to viewing content that the platform. administrator has made public. If a registered user finishes interacting with the site 410 or an unregistered user finishes viewing the site, the user logs out of his account, if applicable, or simply leaves the website 411.

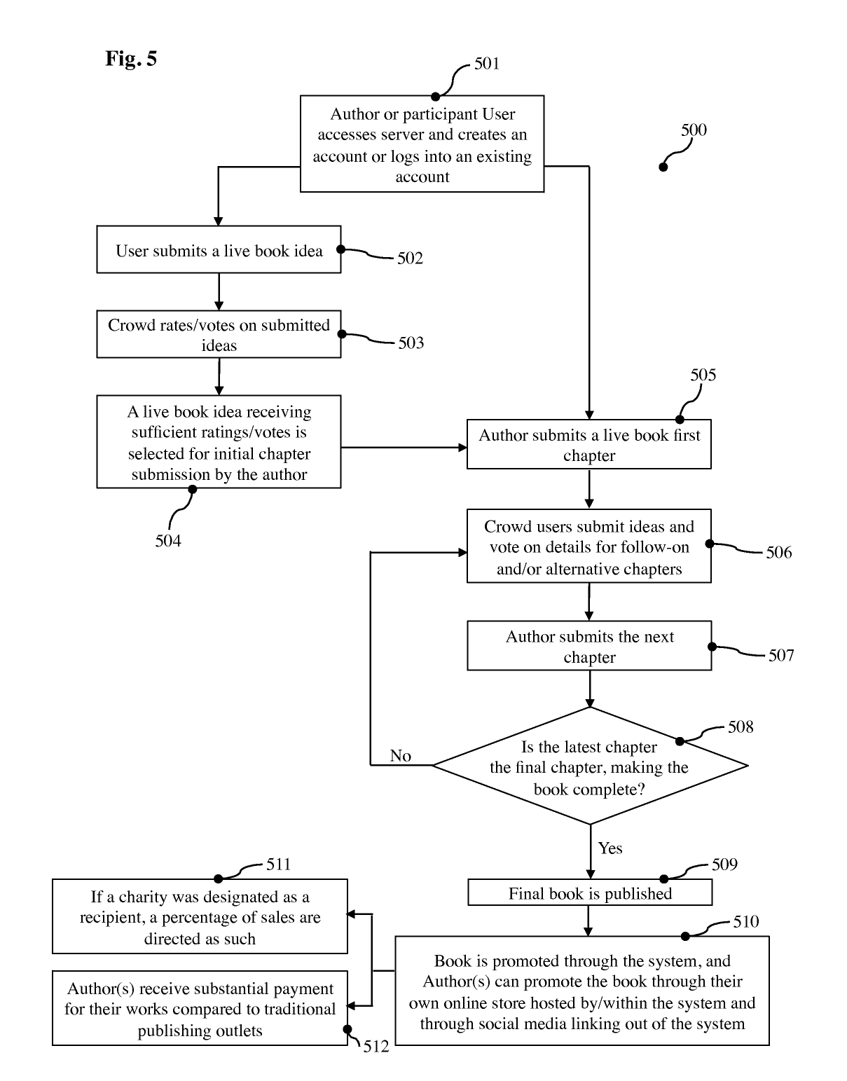

FIG. 5 is a flow diagram of a method of crowdsourcing a live book 500. A user—who may be an author or a general viewing or contributor accesses the platform via a website and either registers for a new user account or logs into an existing account 501. A user can then submit an idea for a live hook 502, upon which the crowd can rate and comment 503 and, if successful, may be advanced to “open” status (i.e., an active live book) 504. Alternatively, a user or “project originator”—may create an open live book by submitting a first chapter for the live book 505. The crowd can submit ideas and vote on details for follow-on or alternative chapters to be written by the original author (the user who submitted the first chapter) or by other uses 506, depending on the type of live book the project originator selected. A project originator or other contributing user then submits the next chapter 507. If the last-submitted chapter is not the last chapter (or alternative chapter) of the book 508, the crowd can submit ideas and vote on details for follow-on chapters 506. If the last-submitted chapter is the final book chapter, the final book is published 509 in a manner pre-arranged by the project originator and/or contributors and the platform administrator. The published book is then promoted through the system (website), and Author(s) can promote the book through their own online store hosted by/within the system and through social media linking outside of the system 510. If a charity has been designated as beneficiary of sales (e.g., the American Cancer Society might be a designated beneficiary of a collection of cancer survivor stories), the established percentage of sales will be directed to that charity 511. The author(s) of the live book will receive a percentage of sales depending on their contribution 512, and in all cases this will be a higher percentage than authors receive from traditional paper or even more modern online publishing houses.

1. A method comprising:
submission of a multiplicity of media themes for theme-based content production by online users;
selection of a submitted theme for content production, based on one or more selection means, by a system administrator;
submission of a multiplicity of content within the selected theme by users;
selection of user-submitted content, based on one or more selection means, for advancement to publication;
compilation of the selected content resulting in a compilation, and publication of said compilation by one or more publication means.

2. The method of claim 1, wherein accessing the content includes accessing a web server containing online content via a website.

3. The method of claim 1 wherein the selection means are comprised of independent selection criteria of a system administrator and user-submitted comments and/or ratings.

4. The method of claim 1 wherein the publication means are comprised of online, other digital, and physical production.

5. The method of claim 1 further comprising the step of crowdsourcing funds finance production of the published media.

6. The method of claim 1 wherein media is of a type from the list: book, music, videos, clips, movies and various types of design such as industrial design, architecture and software.

7. The method of claim 1 further comprising the step of providing payment to whole and partial content contributors (users who contributed content appearing in the compilation).

8. The method of claim 1 further comprising the steps of designating a charity whose mission is related to the selected them and providing payment of a designated amount to said charity based on sales of the compilation.

9. A method comprising:
accessing an online system;
selecting a media type from a pre-defined list for contribution;
selecting one or more roles from a pre-defined list to play in media collaboration;
contributing or revising content as appropriate within the selected role.

10. The method of claim 9 wherein the media type is music.

11. The method of claim 10 wherein user selects one or more roles from a list comprising: producer, singer, instruments, songwriter, lyricist and rapper.

12. The method of claim 9 wherein the media type is engineering design.

13. The method of claim 12 wherein user selects one or more roles from a list comprising: designer, CAD, thermal, stress, controls, mass properties, electronics, programming, reliability and quality.

14. The method of claim 9 wherein the media type is a video.

15. The method of claim 14 wherein user selects one or more roles from a list comprising: director, screenwriter, storyboarding, wardrobe, casting, makeup, animation, actor, storywriter, soundtrack, extra, sound effects, visual effects and computer animation.

16. A method comprising:
accessing a server and logging into a user account;
initiating a book project;
receiving crowd input;
submitting follow-on content within said book project;
publishing said book project by one or more publication means;

17. The method of claim 16 wherein accessing a server and logging into an account includes either creating a new user account or accessing an existing user account.

18. The method of claim 16 wherein initiating a book project means either submitting a book idea or submitting the first section (e.g., first chapter) of a new book.

19. The method of claim 16 wherein receiving crowd input means either receiving ratings and/or comments on the initiated book project or receiving ideas and/or content for follow-on section (e.g., chapter 2) from the crowd (i.e., other online users of the system).

20. The method of claim 16 further comprising the step of providing payment to the book project initiator.
